(19) United States
(12) Patent Application Publication
(10) Pub. No.: US 2006/0213997 A1
(43) Pub. Date: Sep. 28, 2006

(54) Method and apparatus for a cursor control device barcode reader

(75) Inventors: Alexander Frank, Bellevue, WA (US); Brian L. Hastings, Fort Collins, CO (US); William J. Westerinen, Sammamish, WA (US); Thomas C. Oliver, Windsor, CO (US); David Rohn, Fort Collins, CO (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/087,263

(22) Filed: Mar. 23, 2005

(51) Int. Cl. G06K 7/10

(52) U.S. Cl. 235/462.15

(57) ABSTRACT

An optical cursor control device, for example, an optical mouse, is adapted to use its array sensor to capture image intensity data associated with barcodes. The image intensity data and associated x-y position data is processed to recreate the barcode image and then is decoded to deliver data to a process running on an associated computer. An apparatus and method are disclosed as well as alternatives to reduce the amount of data sent between the cursor control device and the computer.

### TECHNICAL FIELD

This patent pertains to cursor control devices and more specifically to a cursor control device adapted to read barcodes.

### BACKGROUND

Barcodes are pervasive in today's society. One-dimension and two-dimension barcodes are used for everything from shipping labels to medical records. There are over 30 standards in use for barcode data applications. The reason barcodes are successful is, in part, because they allow robust labeling and subsequent data capture with almost no impact on the cost of the item being scanned, that is, a relatively small printed label. Additionally, barcodes allow capture of data that would be difficult, or at least tedious to enter by hand.

Modern payment techniques, such as telephone scratch cards, particularly those using public key technology, involve the use of long sequences of characters, numeric and otherwise. It is a natural progression to use barcodes for the capture of long character sequences such as payment card numbers, but most personal computers and some business computers are not equipped to capture barcode data.

### SUMMARY

According to one aspect of the disclosure, a cursor control device, for example, an optical mouse, is adapted to report data corresponding to a barcode pattern for processing. The data may include x-y position data of the mouse, mouse velocity data, or image intensity readings corresponding to the barcode pattern itself. The data may be processed in the mouse, processed in the computer, or a combination of the two may process the data. After processing the barcode pattern into character data, the character data may be used as input in a process running on a computer. For example, barcode data on a scratch card may be captured and used in the payment process for enabling use of a pay-as-you-go computer.

The cursor control device, which normally reports x-y position and button data may now additionally report intensity data that may be used to recreate the barcode pattern for decoding. Instantaneous position data may be used to determine velocity that in turn is used with the intensity data to determine barcode feature size and spacing. Various algorithms may be used for anti-aliasing when needed.

### BRIEF DESCRIPTION OF THE DRAWINGS

FIG. 1 is a simplified and representative block diagram of a computer;

FIG. 2 is a perspective view of the top of a representative cursor control device.

FIG. 3 is a bottom view of the cursor control device of FIG. 3;

FIG. 4 is a block diagram of a simplified and representative cursor control device;

FIG. 5 is a representative barcode; and

FIG. 6 is a flow chart of a method for capturing barcode data using a cursor control device with an optical sensor.

### DETAILED DESCRIPTION OF VARIOUS EMBODIMENTS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

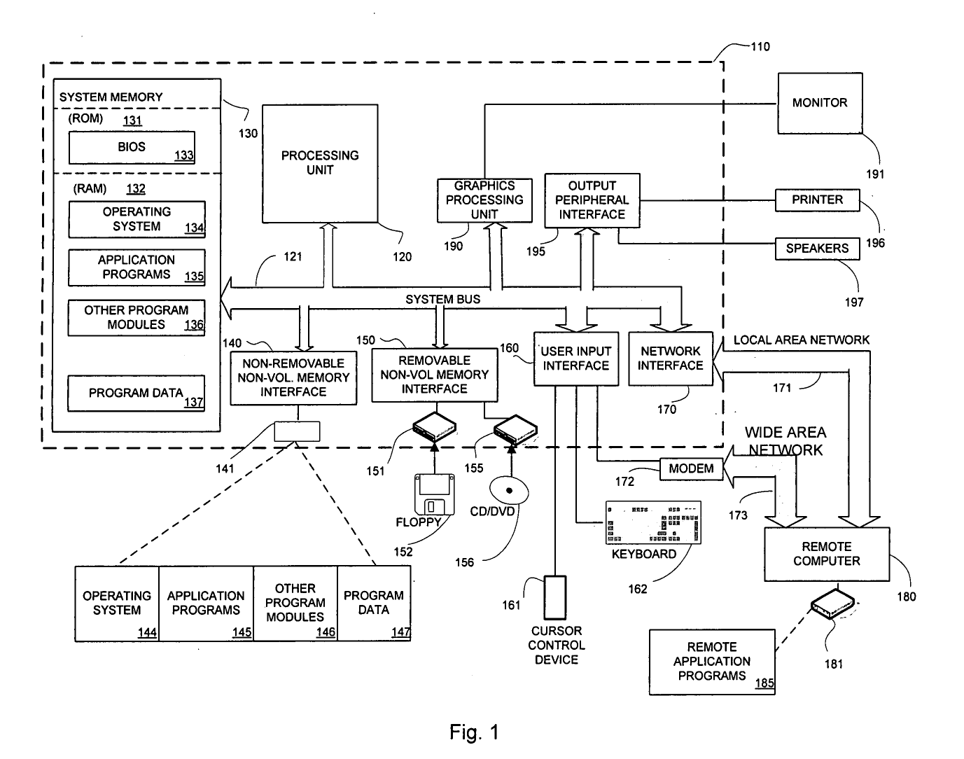

FIG. 1 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). Peripherals, such as the cursor control device 161 or keyboard 162 may also be connected to the computer 110 via a Bluetooth™ or other wireless connection, known in the industry. A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

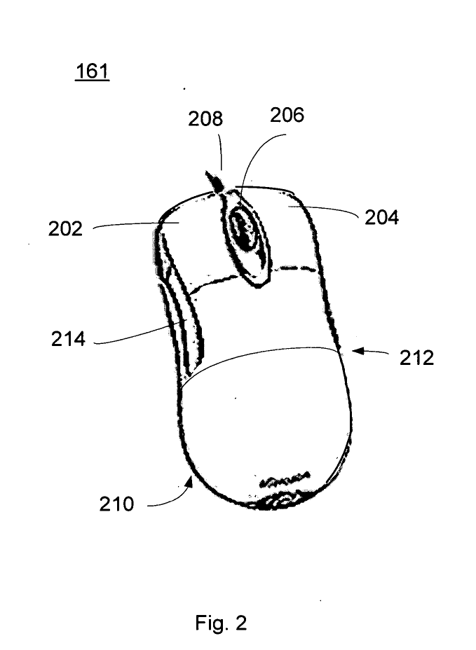

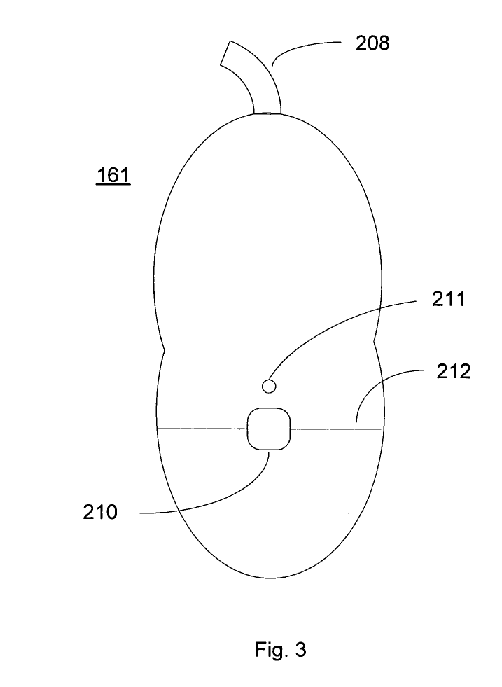

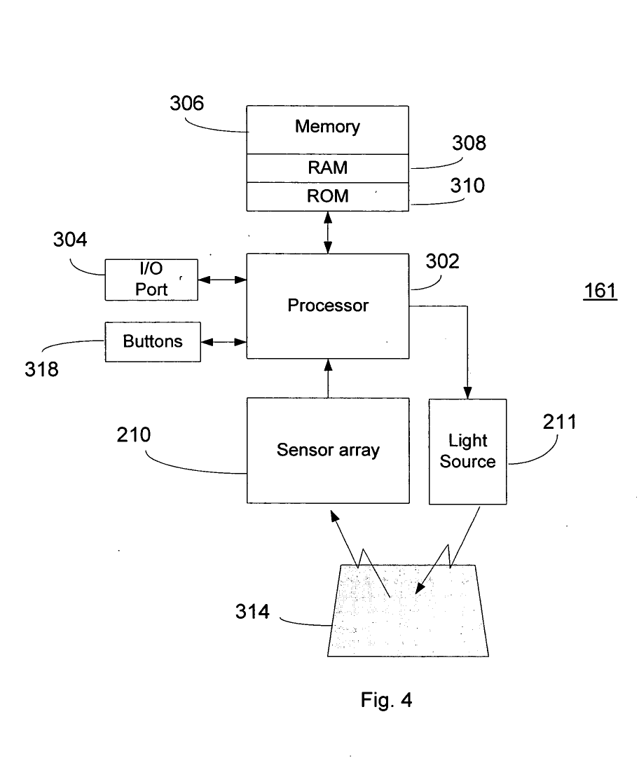

FIGS. 2 and 3 show top and bottom views, respectively, of a representative cursor control device 161, such as an optical mouse. The cursor control device 161 may have a left button 202 and right button 204. The cursor control device may also have a one-dimension or two-dimension wheel 206, that is, the wheel may roll and may also report vertical movement. A cord 208 may couple the cursor control device 161 to the computer 110. Alternatively, the cursor control device 161 may be coupled wirelessly to the computer 110. A sensor array 210 measures reflected light from a surface. The cursor control device 161 may include a light source 211 for illuminating the surface under the cursor control device 161. The sensor array senses the intensity of light reflected from the light source 211. A processor (see FIG. 4) in the cursor control device 161 may be used to process the data received from the array sensor. An indicia 212 may be used to align the optical sensor 210 with a barcode. The indicia 212 is shown as a line but may be any mark, notch or other indicator that would give a user an alignment point for scanning. Additional lights or indicators (not depicted) may be present on the cursor control device 161. These additional lights or indicators may be used to indicate additional status to the user, for example, ready to scan barcode, barcode scanning in process, scan complete, error, normal mode/barcode mode. Optionally, a mode button 214 may be used to indicate that the cursor control device 161 should be changed between motion-sensing modes and barcode sensing modes.

FIG. 4 illustrates a representative block diagram for an optical cursor control device. A processor 302 communicates with a host, such as computer 110 via an input/output (I/O) port 304. The cursor control device 161 may also have a memory 306. The memory 306 may be separate or may be part of the processor 302. The memory 306 may include both random access memory (RAM) 308 and a non-volatile memory such as read-only memory (ROM) 310. Alternately, the ROM may be an erasable programmable memory (EEPROM) or the like, persisting variable and setting data through power cycle events. The sensor array 210 may use the light source 211 to illuminate a surface 314. Light reflected from the surface 314 may be captured by the sensor array 210. Data from the sensor array 210 may be coupled back to the processor 302 for transmission or processing. Buttons 318, for example, buttons 202, 204, 214 of FIG. 3, may be coupled to the processor 302. The buttons usually represent a single input, but the cursor control device 161 may include a wheel, such as wheel 206, that has both motion and direction indicators. As mentioned above, one of the buttons may be used to start and stop the barcode scanning mode.

The processor 302 may be a single-chip controller, such as those available from Intel and Freescale Semiconductor. Custom implementations of the processor 302 may also be used to address power requirements and sensor integration. Practitioners of ordinary skill in the art are capable of specifying such as custom implementation. Software code may be used to facilitate the optical scanning, input detection and communication tasks associated with the cursor control device 161. The ROM 310 may be used to store the software code. The RAM 308 may be used for scratchpad memory for calculations and parameter data, as well as for storing data captured by the sensor array 210, for example when forming a series of snapshots of pixel array data.

The light source 312 may be a solid state device, such as a light-emitting diode (LED). An LED implementation may be suitable because of its power consumption and durability. A coherent light source or an incandescent light source are possible as well. The sensor array 210 may be a charge-coupled device (CCD) array, a complementary metal oxide semiconductor (CMOS) device, or other optical sensor. While higher levels of grayscale detection may be valuable for motion detection, the barcode scanning process requires only 1 or 2 bits of optical sensing level, that is, in most cases the barcode patterns require only on/off indications.

A cursor control device 161 using an optical sensor may report motion data to the computer 110 via I/O port 304, for example, a universal serial bus (USB) at a rate of about 125 reports per second. Reports may typically contain 3-6 bytes of information including x-y data, wheel activity, and button state. The array sensor 316 may process “image” data at a much higher rate and compare images to determine relative motion of the cursor control device across the surface 314 by pattern matching the reflected images. The combination of array size and image capture rate determine the maximum speed the cursor control device may be moved with accurate reporting. To illustrate using a trivial example, if the cursor control device 161 has a 0.5 inch square sensor and scans twice per second, the cursor control device 161 could move no more than 1 inch per second before any overlap between images would disappear (0.5 inch coverage/scan*2 scan/second=1 inch coverage/second). Higher image scanning rates allow faster cursor control device 161 movement but may create data in excess of what can be transmitted to the computer 110, therefore some data processing associated with motion sensing may take place in the cursor control device 161.

However, when in a mode for scanning barcodes, the same data may not be required as when motion sensing. Therefore different image capture and processing steps may be followed. The overall problem of interpreting barcodes may be broken down into two steps: determining the barcode pattern and decoding the barcode pattern into characters.

Decoding character data from the barcode pattern requires determining the width of the bars and their spacing. In many of the various barcode standards, the width of the bars and width of the space between bars are used to determine the coded data values. Factors when processing the barcode pattern may include the speed the array sensor moves across the bars, changes in speed during sensing, and any angle of motion with respect to the bars affect the apparent bar width and spacing.

A factor in reading barcode patterns may be variations in distance between the sensor array 210 and the surface 314. While optical sensing for simple motion detection may be forgiving in this respect, variations in the surface being scanned for a barcode pattern may not be uniform, or even flat. For example, a beverage company may offer reward “points” by including a barcode on the side of a soft drink can. The sensing array 210 may include an auto-focus capability either using a movable lens (not depicted) or by movably mounting the sensor array 210 with respect to a fixed lens (not depicted). For example, the sensor array 210 could itself be mounted on a piezoelectric transducer for making such adjustments.

Another factor in reading barcode patterns is ambient light or lack of contrast in the barcode that causes the array sensor 316 readings to skew to one end or the other of the sensing range. A way to compensate for these potentials is to average the pixel intensity values over the length of the barcode image and then adjust the pixel values, linearly or otherwise, so the average reading is scaled to be at the center of the black/white, or on/off, range. Adapting the sensor array 210 or the optics analysis process to implement an automatic gain control (AGC) may also be used to address variations in ambient light and illumination intensity. Automatic gain control functionality is well known in optics and image processing.

Ambient light and contrast notwithstanding, higher levels of grayscale processing used for motion sensing may not be required because of the monochrome nature of barcodes. However, even when scanning at reduced grayscale depth, the amount of image data captured may be too much to send to the computer in real time. Cost-effective bandwidth is likely to increase in the future, but for now the bandwidth limitations of the current I/O ports, such as port 304, may dictate that all the sensor data normally processed for motion detection cannot be passed to the computer 110. Therefore, steps may be needed to reduce the amount of data sent via I/O port 304. Three such scenarios are discussed in the following paragraphs, full processing on board, reduced data capture, and data reduction on board.

When fully processing data on board the cursor control device, a relatively large amount of data may be available for determining barcode patterns. The first step, determining the barcode pattern, may be relatively simple because the full sensor array may be employed at a high rate of scanning. Aliasing may be reduced by the high scanning rate coupled with the relatively large footprint of the array since the sensor could conceivably span an entire bar or space. Barcode noise, that is, dirt or other damage to the original barcode pattern, may be averaged out using readings from across the array. The edges of the bars may be evaluated, along with x-y data, to determine and correct for scanning angles. Decoding the captured barcode may involve storing or downloading the appropriate barcode standard for the object being scanned. For example, a scratch card may use a different barcode format from a barcode used to store a universal record locator (URL) in a printed advertisement. After decoding the barcode image, character data may be transferred to the computer 110 using the existing packet protocol, generally maintaining the 3-6 byte per packet size.

When no image data is processed in the cursor control device 161, steps may be taken on board the cursor control device 161 to reduce the amount of data captured. In one embodiment, only slices of data may be taken, for example, an image slice may be captured that is a subset of the full array, for example, a 1×n pixel array. If dirt or print quality are issues, the image slice may be parallel with the bars of the barcode. This mode relies on accurate x-y position data to allow assembly of vertical rasters to recreate the image. Alternately, a 1 pixel deep slice the full width of the array may be captured that represents a slice taken perpendicular to the bars of the barcode. Here, successive images may be stitched together on the computer 110 using both the x-y data and edge matching. In either case, each slice representing a pixel image array of monochrome or two-bit grayscale data and corresponding x-y information may be fit into the existing 3-6 byte data transfer packet. Higher grayscale levels could be used with the existing transfer packet, but would result in an overall lower data transfer rate. The barcode image would be recreated by a process on the computer 110 using either raster assembly or image stitching and then decoded according to one of the various standards. Automatic recognition of some of the more common standards may be used, while in other circumstances, the user may be asked to select a representative barcode or data type to help the computer 110 select an appropriate decoding standard.

Another method for reducing the amount of data captured at the cursor control device 161 may be to sample very small pixel arrays, for example, 2×2 data. The raw data for each 2×2 array and, when available, corresponding x-y data can be transferred to the computer and used to recreate the barcode image. Accurate x-y data and prior knowledge of the barcode pattern type may be required to prevent aliasing in this scenario.

A hybrid approach, using image processing in both the cursor control device 161 and the computer 110 may be employed to perform data reduction in the cursor control device 161. For example, when sampling a 1-x-n or n-x-1 array, the data may be run-length encoded to reduce the amount of data transmitted to the computer 110. In another example, data from a larger area may be sampled, for example, an 8×8 pixel array and use a compression technique such as discrete cosine transform (DCT) to arrive at an average value for the sample. All dark or all light images would have high values at either end, where images containing edges would fall in the middle and may be easily distinguished. The DCT values in combination with x-y information may be sent to the computer 110 using the existing protocol, and the barcode image may be recreated and then decoded on the computer 110.

In another hybrid embodiment, the mouse may measure the width of each bar by examining the 1×N array to determine the location of transitions. The cursor control device 161 may then transmit width and polarity data associated with the barcode for further processing by the computer 110.

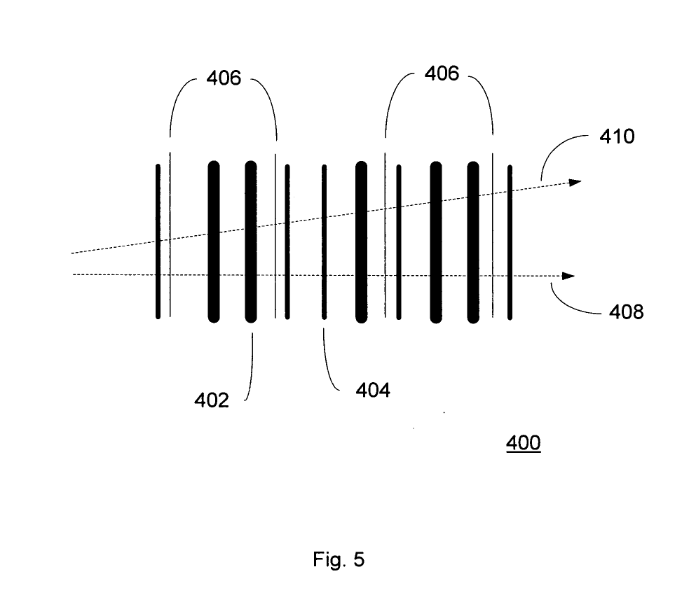

In any of the above examples, the barcode itself may be adapted to aid in the image recreation and decoding processes. Referring to FIG. 5, a representative barcode is discussed. The barcode data may include both wide bars 402 and narrow bars 404. In some cases, the space between bars is significant, i.e. an absence of a bar. Special alignment marks, for example, the four lines 406, in this case evenly spaced may be interspersed with the actual bars representing data. The alignment marks 406 may be used for determining speed and relative positions. When scanning the barcode pattern, the cursor control device 161 may move perpendicularly to the pattern, as shown by scan path 408. However, the scan path may not be perpendicular, as shown by scan path 410, in fact, the scan path may not even be linear. In one embodiment, the alignment marks are narrower than the width of a single scanned image frame, that is, narrower than a minimum image width of a single scan. This allows sensing both edges of the alignment mark in a single image. The alignment mark may be easily identified because it is the only expected feature that is less than the width of the sensor array. By interpreting the reported width and the distance between alignment mark scans, alone or in combination with x-y movement data, routine math may be used to adjust for scanning speed and alignment to reproduce correct bar width and spacing.

In operation, a user may begin a payment process or other transaction that can be aided by scanning a barcode. At some point in the process, the user may be presented with a form requiring user input. Instead of tediously copying a lengthy code into the computer, the code may be captured by scanning an associated barcode. In one embodiment, using the pay-as-you-go computer example, when the user realizes that more usage credits must be added to the computer, the user may purchase a scratch card at a local convenience store. A coating may be removed to reveal the code number and corresponding barcode pattern. The user navigates to a website for recharging the usage credit of the computer and is presented with a form to enter the code number from the scratch card. The user may locate the cursor in the data entry field, press the mode button 214 and swipe the cursor control device 161 across the barcode pattern on the scratch card.

In an alternate embodiment, rather than send a signal to the cursor control device 161, either manually of from the computer 110, sensing may take place as if a barcode is continually present. The processor 302 or data sent from the cursor control device 161 to the computer 110 may constantly analyze incoming data to determine if the information may be resolved into barcode patterns and subsequently to data associated with a barcode. When barcode data is present, a signal to all barcode-aware applications may be sent indicating that barcode data is available.

One element of the subsequent data sent to the computer 110 may be an indicator that the mouse is in a mode for scanning barcodes that would alert the computer 110 that data associated with a barcode was attached. The numbers corresponding to the barcode may be placed in the data entry field and the user may release the mode switch 214, or click it again, to place the cursor control device 161 back in the motion sensing mode. In an alternate embodiment, the computer 110 may send a signal to the cursor control device 161 to initiate the barcode scanning mode. A similar signal may be used to place the cursor control device 161 back in the motion sensing mode. An indicator on the cursor control device 161 or on the monitor 191 may alert the user to the change in mode, for example, the indicia 212 may be illuminated when in the barcode sensing mode. Alternately, a pop-up window, perhaps incorporating a rendering of the barcode pattern as scanned, may be used to indicate the mode change to the user. The pop-up may also include the other mode indicators discussed above, briefly, mode and progress indicators. In yet another embodiment, a sound may be played to serve as an indicator to the user of the change in barcode scanning mode.

The process interpreting the barcode pattern, for example, a dynamic link library (dll) on the computer, may assist the user by drawing the recreated barcode pattern on the screen during the scanning process. Feedback to the user may be displayed on the computer screen or display as well, suggesting better alignment between the barcode image and the sensor indicia 212, or speed adjustments to make when re-scanning is required. When the computer has prior knowledge of the barcode type, more accurate instructions may be displayed to the user because expected bar widths and overall length may be known. The instructions may include minimum or maximum scanning rates or to check on skew between the cursor control device 161 and the barcode pattern.

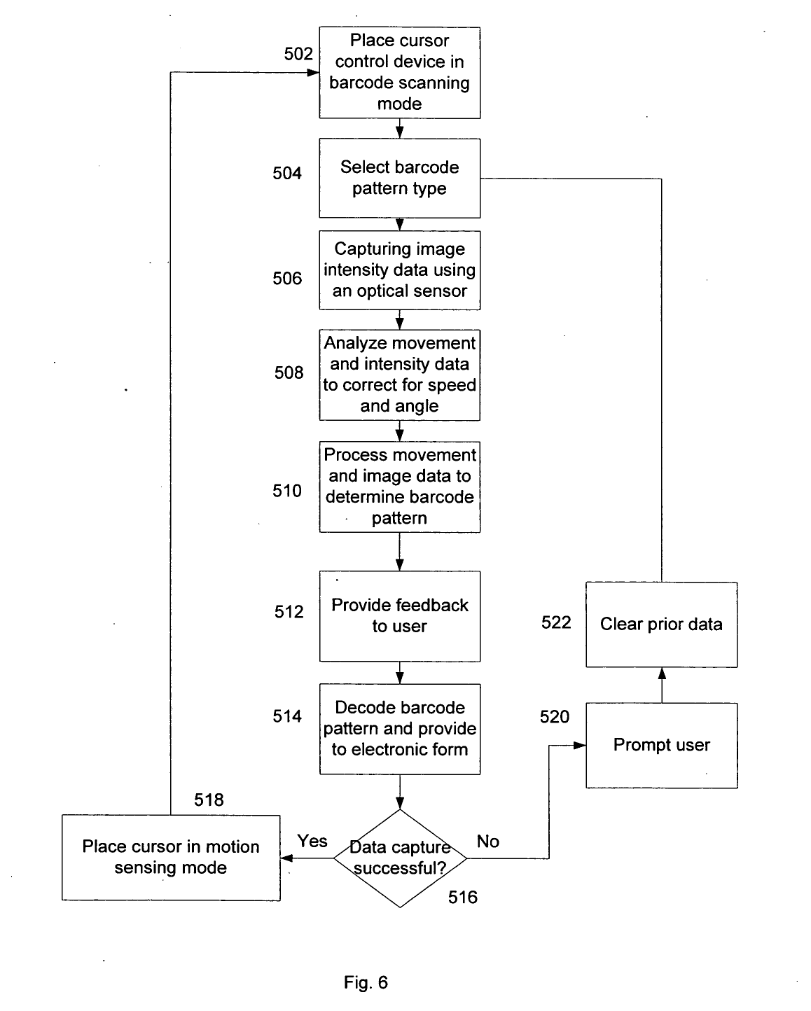

FIG. 6, a method of capturing barcode data using a cursor control device with an optical sensor is discussed and described. A cursor control device 161 may be placed 502 into a mode suitable for scanning a barcode. The mode selection may be accomplished by activating a button on the cursor control device 161 or the selection may be sent to the cursor control device 161 via a communication port 304. Because of the number of different standards in use for barcodes, for example, Code 39, UPS, ISBN, etc., the user may be prompted 504 to select a barcode pattern type for processing subsequent movement and image data captured by the cursor control device 161. Representative barcode-pattern types or a list of applications may be displayed for selection by the user. Alternately, the user may scan the barcode with the cursor control device 161 and the computer may first analyze the captured barcode pattern to determine a barcode type. By first identifying a likely barcode type, a proper algorithm may be selected for interpreting that particular barcode pattern. Barcode pattern selection may be particularly important when capturing 2-D barcodes that require multiple passes to stitch sensor images together to obtain the full barcode image for processing.

After being placed in the correct mode and optionally selecting a barcode pattern type, an indicator on the cursor control device 161 may be activated, for example, an alignment indicia 212 may be illuminated to show the cursor control device 161 is in the barcode scanning mode. The cursor control device 161 may be moved over the barcode pattern and image intensity data may be captured 506 by an optical sensor, for example, array sensor 316. The image intensity data and movement data corresponding to cursor control device 161 speed and direction may be analyzed 508 to compensate for user variation when scanning. Feedback to the user may be provided 512 to help the user align the cursor control device 161 with the barcode and to adjust to an appropriate direction and speed across the barcode pattern. The movement and image data may be processed 510 to recreate the barcode pattern, which may then be decoded 514 using an appropriate barcode standard to provide data to a process running on the computer, for example, an electronic form. When the computer is automatically detecting barcode-pattern type, the flow may change slightly, for example, the computer may first determine the barcode-pattern type before actually decoding the barcode at block 514.

At the completion of the scanning process, indicated by a button click or by cessation of movement, a validity check of the data captured may be performed 516. If the data is complete and in the correct format, further checking, such as a hash may be made. If the data capture was successful, the yes branch from block 516 may be taken. The cursor may be placed 518 in a motion sensing mode and normal operation continued until another barcode scanning event is started at block 502. When the scanning process is not successful, the no branch from block 516 may be taken. The user may be prompted 520 to rescan the barcode. The prompt may include suggestions such as checking alignment and controlling the speed of movement. The previously captured data may be cleared 522 and the process restarted at block 504, where the user may be prompted to re-select a barcode type, for example, from the representative barcode types or applications.

Obviously, the design of a cursor control device 161 may vary appreciably from the one depicted based on factors from ergonomics and industrial design to cost and styling. The number, function and placement of buttons, type and location of alignment indicia, and connection type are but a few variations that may occur in practice.

The discussions above are focused on barcodes. It is clear that the scanning function of the cursor control device 161 may be adapted for other scanning purposes beyond simple barcodes. An increased array size, now currently limited by price, may allow for capture of full characters as input for an optical character recognition (OCR) process. An OCR capability could be applied to magnetic ink character recognition (MICR) symbols used on checks, or even simple text from a book or magazine. As the size of the sensor array 210 increases more general purpose scanning may be accommodated, for example, scanning business cards for completing contact information or using barcodes for document lookup. Additional embodiments may allow entry of universal record locators (URLs) for navigating the Internet. As mentioned above, multiple passes of a cursor control device 161 in barcode scanning mode may enable stitching in both vertical and horizontal directions to capture a two-dimension barcode. 2-D barcodes are capable of storing data at a higher density than is possible using the simpler one-dimension barcode discussed above.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A computer arranged and adapted to process data associated with a barcode pattern comprising:
a cursor control device adapted to sense the barcode pattern;
a port coupled to a cursor control device;
a processor coupled to the port for receiving data corresponding to the barcode pattern, the data comprising cursor control device position data and image intensity data, wherein the data is processed as input data for a process running on the computer.

2. The computer of claim 1, wherein the cursor control device is further adapted to receive a signal to initiate a barcode scanning mode, wherein the signal is one of a button activation and a communication from the computer.

3. The computer of claim 1, wherein the processor uses features in the barcode pattern to correct for at least one of speed over a surface and alignment of the cursor control device with the barcode pattern.

4. The computer of claim 1, wherein the computer detects a barcode type using the position data and image intensity data.

5. The computer of claim 1, wherein the computer provides feedback corresponding to one of cursor control device speed and cursor control device alignment with the barcode pattern.

6. The computer of claim 1, wherein the processor uses predetermined features of the barcode pattern to adjust for cursor control device speed.

7. The computer of claim 1, wherein the processor displays information corresponding to the barcode pattern as the data corresponding to the barcode pattern is received.

8. The computer of claim 1, wherein the processor stitches together intensity data corresponding to the barcode pattern before processing the data as input characters.

9. The computer of claim 1, further comprising an indicator that the cursor control device is in a mode for scanning the barcode pattern.

10. A method of capturing data using an optical cursor control device comprising:
capturing image intensity data using sensor array in a cursor control device;
processing the image intensity data to provide movement and image data to determine a data pattern, wherein the movement data is used to compensate for cursor control device speed; and
sending data corresponding to the data pattern to an electronic form.

11. The method of claim 10, further comprising:
analyzing the movement and image data to correct for at least one of cursor control device angle with respect to the data pattern and cursor control device speed.

12. The method of claim 10, wherein the data pattern is a barcode, the method further comprising:
selecting the barcode pattern type for processing the movement and image data.

13. The method of claim 10, further comprising:
performing an optical character recognition on the data pattern.

14. A cursor control device adapted for scanning a barcode pattern comprising:
a light source illuminating a scanned surface;
a sensor array for sensing light intensity reflected from the illuminated surface;
a processor coupled to the sensor array for determining relative position based on data from the array sensor, wherein the relative position data is used for compensating for cursor control device speed when scanning the barcode pattern; and
a port for sending data corresponding to a barcode from the cursor control device to a computer.

15. The cursor control device of claim 14, wherein the processor is responsive to a signal for setting a barcode sensing mode.

16. The cursor control device of claim 15, further comprising an automatic gain control for normalizing the light intensity reflected back from the illuminated surface.

17. The cursor control device of claim 14, wherein the data is at least one of velocity, bar width, cursor control device position, light intensity data and character data.

18. The cursor control device of claim 14, further comprising a focusing apparatus to compensate for variations in distance between the sensor array and the illuminated surface.

19. The cursor control device of claim 14, further comprising at least one indicia for aligning the cursor control device with the barcode pattern.

20. The cursor control device of claim 14, further comprising an indicator for alerting a user that the cursor control device is in a barcode sensing mode.
